(19) United States
(12) Patent Application Publication
(10) Pub. No.: US 2018/0261854 A1
(43) Pub. Date: Sep. 13, 2018

(54) Thin Fluid Manifolds and Methods Therefor

(71) Applicant: Intelligent Energy Limited, Loughborough (GB)

(72) Inventors: Jeremy SCHROOTEN, Loughborough (GB); Paul SOBEJKO, Loughborough (GB); Joerg ZIMMERMANN, Loughborough (GB); Isabelle DEPATIE, Loughborough (GB); Simon FOSTER, Loughborough (GB); Christopher KIRK, Loughborough (GB); Vincent FAUCHEUX, Loughborough (GB)

(73) Assignee: Intelligent Energy Limited, Loughborough (GB)

(21) Appl. No.: 15/974,550

(22) Filed: May 8, 2018

Related U.S. Application Data
(63) Continuation of application No. PCT/US2016/059567, filed on Oct. 28, 2016.
(60) Provisional application No. 62/252,917, filed on Nov. 9, 2015.
(60) Provisional application No. 62/248,820, filed on Oct. 30, 2015.

(51) Int. Cl. H01M 8/0258; H01M 8/2483; H01M 8/1007; H01M 8/04119

(52) U.S. Cl. CPC H01M 8/0258; H01M 8/04156; H01M 8/1007; H01M 8/2483

(57) ABSTRACT

A fuel cell system with planar manifold having at least one fuel cell assembly with a first side and a second side; a plurality of anodes on the first side; a plurality of cathodes on the second side; ion-conducting electrolyte between the first and second sides; a fluid manifold assembly fluidly connected to the first side. In the planar manifold a first barrier layer provides at least one inlet port in fluid communication with a hydrogen source, and at least one outlet port to remove any unreacted hydrogen and byproducts from the first side; a plurality of conduit layers, on at least one of which is disposed one or more channels fluidly connected to the at least one inlet port and one of which is fluidly connected to the at least one outlet port; and, a second barrier layer disposed above the plurality of conduit layers containing a plurality of perforations affixed to the first side to supply hydrogen gas.

### PRIORITY OF INVENTION

This application claims priority to U.S. Provisional Patent Application No. 62/248,820 filed Oct. 30, 2015, and to U.S. Provisional Patent Application No. 62/252,917 filed Nov. 9, 2015, which is a continuation-in-part of U.S. patent application Ser. No. 14/918,481 filed Oct. 20, 2015, which is a continuation of U.S. patent application Ser. No. 13/361,808, filed Jan. 30, 2012, which is a continuation of U.S. patent application Ser. No. 12/053,366, filed Mar. 21, 2008, which application claims the benefit of priority under 35 U.S.C. § 119(e) to U.S. Provisional Patent Application No. 60/919,472, filed Mar. 21, 2007, which applications are herein incorporated by reference in their entirety.

### FIELD

The present document relates to fluid management technology. More specifically, it relates to fluid manifolds.

### BACKGROUND

Trends in technology are progressing towards smaller scales for systems in a variety of applications. Fluidic systems can be integrated within restrictive form factors imposed by the system to manipulate the transport of fluid. For example, flow-modulating components can be arranged for functions such as reactant delivery, heat transfer, and dosing of fluids.

Electronic components, such as personal electronic devices, are trending to become smaller in size. As electronic components are designed to be smaller in size and incorporate sophisticated and complex technology, the demands on power supply become greater. For instance, the power supply may need to occupy less volume or a smaller footprint to accommodate the addition of the technology to the device. Some applications may also require that the power supply last for longer periods of time.

An example of a power supply for the electronic components is an electrochemical cell system such as a hydrogen supplied fuel cell. In order to make a smaller electrochemical cell system, many individual components of the system, such as a fluid delivery component, can be made smaller, but need to meet the technical requirements of the electrochemical cell system. For instance, the fluid delivery component may need to maintain a certain pressure, without occupying an overall significant volume of the electrochemical cell system, and without interfering with the assembly of the electrochemical cell system. Furthermore, the functionality of the electrochemical cell system must not be compromised. U.S. patent application Ser. No. 14/918,481 discloses fuel cells and methods with reduced complexity, and is incorporated by reference in its entirety as if fully set forth herein.

### DISCLOSURE

Disclosed herein are aspects of methods and devices including introducing fluid, such as a fuel, into a fluid manifold, the manifold including two or more featured layers each having a plurality of conduit channels. In an example, the fuel includes a gas or a liquid such as, but not limited to, hydrogen, methanol, ammonia, silanes, formic acid butane, or borohydrides. The method further includes flowing fluid through the conduit channels. The conduit channels include, but are not limited to, fuel channels, feedback channels, or delivery channels.

Disclosed herein are aspects of methods and devices including providing a fuel to a fuel cell assembly, where a fluid manifold is fluidly coupled with the fuel cell. The method optionally includes flowing material such as a fuel from a first layer recess of a first conduit layer to a second layer recess of a second conduit layer, and/or flowing material through a porous substrate within at least one of the one or more conduit channels, and/or providing a heat transfer fluid to an electrochemical cell system through the conduit channels. The method further optionally includes providing oxidant to an electrochemical cell system through the conduit channels or removing water from the electrochemical cell system through the conduit channels.

Other aspects of methods disclosed herein are flowing fluid through one or more conduit channels includes flowing fluid along a partially recessed channel in the conduit layer, and/or flowing fluid through one or more conduit channels includes directing material along a first partial channel in the first side and along a second partial channel in the second side.

In some instances, the method includes coupling with a charge port, and/or coupling with fuel storage. In still another option, the method further includes distributing fluid on two or more layers via at least a first flow path, the first flow path extending from a first featured layer to a second featured layer, and returning from the second featured layer to the first featured layer.

Disclosed herein are aspects of methods and devices including a fuel cell system with planar manifold having a fuel cell assembly with a first side and a second side; a plurality of anodes on the first side; a plurality of cathodes on the second side; an ion-conducting electrolyte between the first and second sides; a fluid manifold assembly fluidly connected to the first side; and, wherein the fluid manifold has a first barrier layer providing at least one inlet port in fluid communication with a hydrogen source, and at least one outlet port to remove any unreacted hydrogen and byproducts from the first side; a plurality of conduit layers, on at least sane of which is disposed one or more channels fluidly connected to the at least one inlet port and one of which is fluidly connected to the at least one outlet port; and, a second barrier layer disposed above the plurality of conduit layers containing a plurality of perforations affixed to the first side; and, whereby the plurality of perforations supplies hydrogen gas. The plurality of perforations may also receive waste and water from the anode and are fluidly connected via the manifold assembly layers to the outlet. The perforations more evenly distribute hydrogen over the first side than if the manifold did not have perforations.

Disclosed herein are aspects of methods and devices including a planar manifold assembly for delivering hydrogen to a fuel cell anode and removing waste and water including a first barrier layer providing at least one inlet port in fluid communication with a hydrogen source, and at least one outlet port to remove any unreacted hydrogen and byproducts from the first side; a plurality of conduit layers, on at least one of which is disposed one or more channels fluidly connected to the at least one inlet port and one of which is fluidly connected to the at least one outlet port; and, a second barrier layer disposed above the plurality of conduit layers containing a plurality of perforations affixed to the first side; and, whereby the second barrier is configured to be sealed to the anode side of a fuel cell assembly and the plurality of perforations supplies hydrogen gas more evenly over the anode then without perforations. In some instances the perforations are between about 1000 microns and about 3000 microns in diameter. In some instances the perforations are between about 100 microns and about 300 microns in diameter. In some instances the more channels intersect. In some instances a portion of at least one channel is curved.

Disclosed herein are aspects of methods and devices including a laminated planar manifold assembly comprising at least one fuel cell assembly with a first side and a second side; a plurality of anodes on the first side; a plurality of cathodes on the second side; an ion-conducting electrolyte between the first and second sides; a fluid manifold assembly fluidly connected to the first side; and, wherein the fluid manifold comprises a first barrier layer providing an inlet port and an outlet port; a manifold layer to supply hydrogen to the anode side of a fuel cell and having a plurality of fluid paths fluidly connected to the at least one inlet port and one or more water/waste outlet channels fluidly connected to the outlet port; a second barrier layer disposed above the first manifold having a plurality of perforations; an exhaust layer having a plurality of channels for collecting water and waste from the anode side of a fuel cell and fluidly connected to the outlet; a third barrier layer disposed above the exhaust layer having a plurality of perforations; whereby the inlet port is in fluid communication with a hydrogen source; the plurality of perforations at least one of which provides a fluid pathway for pressurized hydrogen gas flowing to the anode of a fuel cell assembly and provides a fluid pathway for water/waste from the anode of a fuel cell assembly.

Disclosed herein are aspects of methods and devices including a planar manifold assembly having a first barrier layer providing an inlet port and an outlet port, a manifold layer to supply hydrogen to the anode side of a fuel cell, and having a plurality of fluid paths fluidly connected to the at least one inlet port and one or more water/waste outlet channels fluidly connected to the outlet port; a second barrier layer disposed above the first manifold having a plurality of perforations; an exhaust layer having a plurality of channels for collecting water and waste from the anode side of a fuel cell fluidly connected to the outlet and having holes fluidly connected to the hydrogen input supply; a third barrier layer disposed above the exhaust layer having a plurality of smaller perforations; whereby the inlet port is in fluid communication with a hydrogen source; and, the plurality of perforations, small perforations and holes at least one of provide a fluid pathway for pressurized hydrogen gas flowing to the anode of a fuel cell assembly and provide a fluid pathway for water/waste from the anode of the of a fuel cell assembly. In some instance a support pedestal above the third barrier layer is added.

In some instances the fluid paths in the manifold have one or more curved regions; the channels in the exhaust layer have one or more intersecting channels; the channels in the exhaust layer have one or more curved regions; wherein the channels in the exhaust layer have one or more curved limbs and/or at least one well (780) is formed at the end of a curved limb.

Disclosed herein are aspects of methods for evenly distributing hydrogen over an anode via a planar manifold, the method comprising forming planar manifold comprising a stack of layers in the following sequence; placing a first layer with a barrier, an inlet port, and an outlet port; placing a second layer with a manifold layer having a plurality of fluid paths fluidly connected to the at least one inlet port and one or more water/waste outlet channels fluidly connected to the outlet port in fluid contact with the first layer; placing a third layer barrier above the second layer manifold having a plurality of perforations each having a diameter of between about 1000 microns and about 3000 microns fluidly connected to the previous layers; placing a fourth layer for exhaust layer having a plurality of channels for collecting water and waste from the anode side of a fuel cell fluidly connected to the outlet and having holes with a diameter of between about 1000 microns and about 3000 microns fluidly connected to the previous layers; placing a fifth layer barrier disposed above the fourth layer having a plurality of smaller perforations each having a diameter of between about 100 microns and about 300 microns fluidly connected to the previous layers; whereby the inlet port is in fluid communication with a hydrogen source; and, the plurality of perforations, small perforations and holes at least one of which provide a fluid pathway for pressurized hydrogen gas flowing to the anode of a fuel cell assembly and provide a fluid pathway for water/waste from the anode of the of a fuel cell assembly. In some instances the combination of selectively sized perforations in several layers more evenly distributing hydrogen over an anode of a fuel cell assembly. In some instances the holes are about 1000 microns to about 2000 microns in diameter, the small perforation are between about 100 microns and about 300 microns in diameter and the perforation are between about 1000 microns and 3000 microns in diameter. In some instances the channels terminate into one or more wells with a diameter of about 30 microns to about 300 microns.

### DRAWINGS

FIG. 1A illustrates an exploded view of aspects of an electrochemical cell system.

FIG. 1B illustrates a block diagram of aspects of an electrochemical cell system.

FIG. 2 illustrates an exploded perspective view of aspects of a fluid manifold.

FIG. 3A illustrates a cross-sectional view of aspects of a conduit layer.

FIG. 3B illustrates a cross-sectional view of aspects of a conduit layer.

FIG. 3C illustrates a cross-sectional view of aspects of a conduit layer.

FIG. 4 illustrates an exploded perspective view of aspects of a fluid manifold.

FIG. 5 illustrates an exploded perspective view of aspects of a fluid manifold.

FIG. 6 illustrates a view of an enclosure with an interface.

FIG. 7 illustrates a side view of an enclosure with an interface.

FIG. 8 illustrates an exploded view of aspects of an electrochemical cell system.

FIGS. 9A-9B show an exploded perspective view and a layer view of aspects of a fluid manifold.

FIGS. 10A-10B illustrate aspects of a fluid manifold for an electrochemical cell.

FIGS. 11A-11C show aspects of multilayered manifolds disclosed herein.

FIGS. 12-14 show aspects of layers of a multilayered manifold.

FIG. 15 shows FLIR infra-red images.

### FURTHER DISCLOSURE

The patent or application file contains at least one drawing executed in color. Copies of this patent or patent application publication with color drawing(s) will be provided by the Office upon request and payment of the necessary fee.

The following detailed description includes references to the accompanying drawings, which form a part of the detailed description. The drawings show, by way of illustration, specific embodiments in which the fluid manifold and fuel cell fuel systems and methods may be practiced. These embodiments, which are also referred to herein as “examples” or “options,” are described in enough detail to enable those skilled in the art to practice the present invention. The embodiments may be combined, other embodiments may be utilized, or structural or logical changes may be made without departing from the scope of the invention. The following detailed description is, therefore, not to be taken in a limiting sense and the scope of the invention is defined by the appended claims and their legal equivalents.

In this document, the terms “a” or “an” are used to include one or more than one, and the term “or” is used to refer to a nonexclusive “or” unless otherwise indicated. In addition, it is to be understood that the phraseology or terminology employed herein, and not otherwise defined, is for the purpose of description only and not of limitation.

A fluid manifold is provided herein. In the following examples, a fuel manifold for an electrochemical cell system is discussed. However, the fluid manifold is not necessarily so limited and can be used in other types of fluidic control systems or other types of systems in need of fluid management. For instance, the fluid manifold can be used to deliver or remove other types of fluids, including, but not limited to gases, hydrogen, water, oxidant, or a heat transfer fluid. For instance, the fluid manifold includes, but is not limited to, a fuel manifold, a heat transfer manifold, an oxidant manifold, or a water removal manifold.

### DEFINITIONS

As used herein, “fluid” refers to a continuous, amorphous substance whose molecules move freely past one another and that has the tendency to assume the shape of its container. A fluid may be a gas, liquefied gas, liquid, or liquid under pressure. Examples of fluids may include fluid reactants, fuels, oxidants, and heat transfer fluids. Fluid fuels used in fuel cells may include hydrogen gas or liquid and hydrogen carriers in any suitable fluid form. Examples of fluids include air; oxygen; water; hydrogen; alcohols such as methanol and ethanol; ammonia and ammonia derivatives such as amines and hydrazine, silanes such as disilane, trisilane, and disilabutane; complex metal hydride compounds such as aluminum borohydride; boranes such as diborane; hydrocarbons such as cyclohexane; carbazoles such as dodecahydro-n-ethyl carbazole, and other saturated cyclic, polycyclic hydrocarbons; saturated amino boranes such as cyclotriborazane; butane; borohydride compounds such as sodium and potassium borohydrides; and formic acid.

As used herein, “fluid enclosure” may refer to a device for storing a fluid. The fluid enclosure may store a fluid physically or chemically. For example, the fluid enclosure may chemically store a fluid in active material particles.

As used herein, “active material particles” refer to material particles capable of storing hydrogen or other fluids or to material particles that may occlude and desorb hydrogen or another fluid. Active material particles may include fluid-storing materials that occlude fluid, such as hydrogen, by chemisorption, physisorption, or a combination thereof. Some hydrogen storing materials desorb hydrogen in response to stimuli, such as a change in temperature, a change in heat, or a change in pressure. Examples of hydrogen-storing materials that release hydrogen in response to stimuli dude metal hydrides, chemical hydrides, suitable micro-ceramics, nanoceramics, boron nitride nanotubes, metal organic frameworks, palladium-containing materials, zeolites, silicas, aluminas, graphite, and carbon-based reversible fluid-storing materials such as suitable carbon nanotubes, carbon fibers, carbon aerogels, and activated carbon, nano-structured carbons or any combination thereof. The particles may also include a metal, a metal alloy, a metal compound capable of forming a metal hydride when in contact with hydrogen, alloys thereof or combinations thereof. The active material particles may include magnesium, lithium, aluminum, calcium, boron, carbon, silicon, transition metals, lanthanides, intermetallic compounds, solid solutions thereof, or combinations thereof.

As used herein, “metal hydrides” may include a metal, metal alloy, or metal compound capable of forming a metal hydride when in contact with hydrogen. Metal hydride compounds can be generally represented as follows: AB, AB2, A2B, AB5, and BCC, respectively. When bound with hydrogen, these compounds form metal hydride complexes.

As used herein, “occlude” or “occluding” or “occlusion” refers to absorbing or adsorbing and retaining a substance, such as a fluid. Hydrogen may be a fluid occluded, for example. The fluid may be occluded chemically or physically, such as by chemisorption or physisorption, for example.

As used herein, “desorb” or “desorbing” or “desorption” refers to the removal of an absorbed or adsorbed substance. Hydrogen may be removed from active material particles, for example. The hydrogen or other fluid may be bound physically or chemically, for example. As used herein, “contacting” refers to physically, chemically, electrically touching or within sufficiently close proximity. A fluid may contact an enclosure, in which the fluid is physically forced inside the enclosure, for example.

As used herein, “composite fluid storage material” refers to active material particles mixed with a binder, wherein the binder immobilizes the active material particles sufficient to maintain relative spatial relationships between the active material particles. Examples of composite fluid storage materials are found in commonly owned U.S. patent application Ser. No. 11/379,970, entitled “Composite Hydrogen Storage Material And Methods Related Thereto,” filed Apr. 24, 2006, which was issued as U.S. Pat. No. 7,708,815 on May 4, 2010, and whose disclosure is incorporated by reference herein in its entirety. An example of a composite fluid storage material is a composite hydrogen storage material.

As used herein, “electrochemical layer” refers to a sheet including one or more active functional members of an electrochemical cell, For example, an electrochemical layer may include a fuel cell layer. As used herein, “active functional members” refers to components of an electrochemical cell that function to convert chemical energy to electrical energy or convert electrical energy to chemical energy. Active functional members exhibit ion-conductivity, electrical conductivity, or both.

As used herein, “electrochemical cell” refers to a device that converts chemical energy to electrical energy or converts electrical energy to chemical energy. Examples of electrochemical cells may include galvanic cells, electrolytic cells, electrolyzers, fuel cells, batteries and metal-air cells, such as zinc air fuel cells or batteries. Any suitable type of electrochemical cell including fuel cells and appropriate materials can be used according to the present invention including without limitation proton exchange membrane fuel cells (PEMFCs), solid oxide fuel cells (SOFCs), molten carbonate fuel cell (MCFCs), alkaline fuel cells, other suitable fuel cells, and materials thereof. Further examples of fuel cells include proton exchange membrane fuel cells, direct methanol fuel cells, alkaline fuel cells, phosphoric acid fuel cells, molten carbonate fuel cells, or solid oxide fuel cells.

An electrochemical cell layer, such as a fuel cell layer, may include one or more anodes, cathodes, and electrolyte interposed between the anodes and cathodes. In a fuel cell system, the cathodes may be supplied with air containing oxygen for use as an oxidizing agent, and the anodes may be supplied with hydrogen, for example, for use as fuel. The oxidizing agent may be supplied from air surrounding the fuel cell system, while the fuel or other reactant fluid may be supplied from the fluid reservoir.

Arrays of unit cells can be constructed to provide varied-power generating electrochemical cell layers in which the entire electrochemical structure is contained within the layer. This means additional components such as plates for collecting currents etc. can be eliminated, or replaced with structures serving different functions. Structures like those described herein are well adapted to be manufactured by continuous processes. Such structures can be designed in a way which does not require the mechanical assembly of individual parts. In some embodiments, the conductive path lengths within this structure may be kept extremely short so that ohmic losses in the catalyst layer are minimized. Array may refer to a plurality of individual unit cells. The plurality of cells may be formed on a sheet of ion exchange membrane material, a substrate, or may be formed by assembling a number of components in a particular manner.

Unit cells according to the invention may be used in a planar electrochemical cell layer that is conformable to other geometries, as described in U.S. patent application Ser. No. 11/185,755, entitled “Devices Powered By Conformable Fuel Cells,” filed on Jul. 21, 2004, which was issued as U.S. Pat. No. 7,474,075 on Jan. 6, 2009; and U.S. Patent Application No. 60/975,132, entitled “Flexible Fuel Cell,” filed Sep. 25, 2007, which are hereby incorporated by reference.

Arrays can be formed to any suitable geometry. Examples of planar arrays of fuel cells are described in co-owned U.S. patent application Ser. No. 11/047,560 entitled “Electrochemical Cells Having Current Carrying Structures Underlying Electrochemical Reaction Layers”, filed on Feb. 2, 2005, which was issued as U.S. Pat. No. 7,632,587 on Dec. 15, 2009, the disclosure of which is herein incorporated by reference. Fuel cells in an array can also follow other planar surfaces, such as tubes as found in cylindrical fuel cells. Alternately or in addition, the array can include flexible materials that can be conformed to other geometries.

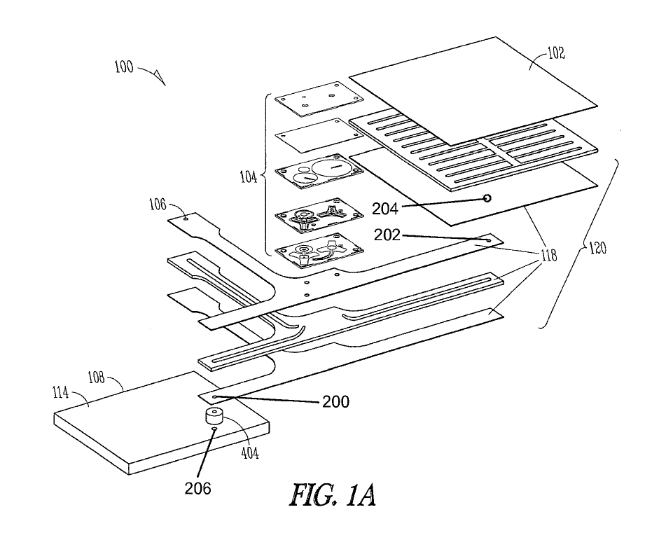

Referring to FIG. 1A, an example of an electrochemical cell system, such as an electrochemical cell system 100 is shown. Although the term electrochemical cell system is used herein, it should be noted that the system can be used for any electrochemical cell system. The electrochemical cell system 100, which may be characterized as a fuel cell assembly, includes one or more of a fuel cell 102, a fuel cell fuel system 104, a charge port 106, and fuel storage 108. The fuel cell fuel system 104 includes a layered structure including, but not limited to, at least one pressure regulator, at least one check valve, at least one flow valve. In an option, the at least one pressure regulator, the at least one check valve, and the at least one flow valve include featured layers that are stacked together and operatively interact together, for example as discussed in co-pending U.S. patent application Ser. No. 12/053,374, entitled “Fluidic Control System And Method Of Manufacture”, filed on Mar. 21, 2008, which was issued as U.S. Pat. No. 8,679,694 on Mar. 25, 2014 and is incorporated herein by reference in its entirety. The electrochemical cell system 100 further includes a manifold 118, such as a fuel manifold 120 fluidly coupled with a fluid enclosure 114, such as the fuel storage 108. The manifold 118 is also fluidly coupled with the fuel cell 102. The fluid coupling for the fuel manifold and the fuel storage can include, but is not limited to compression seals, adhesive bonds, or solder connections. Although a fuel manifold is discussed as an example, the manifold can also be used to distribute, deliver, or remove other types of fluids, such as, but not limited to water, oxidant, or a cooling fluid.

Devices for detachably coupling the fluid coupling, such as a pressure activated valve, can be used. For example, pressure activated one-way valve allows a flow of fluid, for example, fluid fuel, into a fluid enclosure for a fuel storage system. The flow of fuel is allowed into a fluid reservoir during refueling, but does not allow fuel to flow back out of the fuel reservoir. In an option, flow of fuel is permitted to flow back out of the fluid reservoir if the fluid reservoir is over-pressurized with fuel.

An external refueling device can form a seal against a portion of the sealing surface, for example, around the inlet port with a seal, such as an o-ring or gasket. Fuel is introduced into the fluid control system, and the fluidic pressure of the fuel compresses the compressible member and breaks the seal between the compressible member and the outside cover. In another option, an environment surrounding the exterior of the outside cover may be pressurized with fuel to force fuel through the refueling valve assembly and into the fuel reservoir.

When the fueling process is complete, the refueling fixture is removed from the valve assembly, and the valve becomes closed. For example, the compressible member decompresses, and fluidic pressure from the fuel reservoir through the fuel outlet port exerts pressure onto the compressible member and presses the compressible member against the outside cover. The decompression of the compressible member and/or the fluid pressure from the reservoir creates a seal between the compressible member and the outside cover such that fuel does not flow past the compressible member and into the fuel inlet port. In another option, the compressible member and/or the fluid diffusion member can be designed to intentionally fail if the pressure in the fuel reservoir becomes too great, or greater than a predetermined amount. Additional examples and details of valves can be found in commonly owned co-pending U.S. patent application Ser. No. 11/621,542, entitled “Refueling Valve For A Fuel Storage System And Method Therefor,” filed on Jan. 9, 2007, which was issued as U.S. Pat. No. 7,938,144 on May 10, 2011 and which is incorporated by reference in its entirety.

In another option, a fluid coupling assembly can be used to couple the system with another component. The coupling assembly includes a first coupling member, a second coupling member, and a seal member therebetween. The first coupling member and the second coupling member are magnetically engagable, such as by way of a first magnetic member and a second magnetic member having attracted polarities. The engagement of the first coupling member and the second coupling member opens a fluid flow path therebetween. When the coupling members are disengaged, this fluid flow path is sealed. Additional examples and details can be found in commonly owned co-pending U.S. patent application Ser. No. 11/936,662, entitled “Magnetic Fluid Coupling Assemblies And Methods,” filed Nov. 7, 2007, which was issued as U.S. Pat. No. 7,891,637 on Feb. 22, 2011 and which is incorporated herein by reference in its entirety.

In a further option, the system includes a strain absorbing interface 404 for contacting the fluid enclosure. For instance, the interface is used for a rigid or semi-rigid component and a flexible fluid enclosure. The interface absorbs any strain due to dimensional changes in the fluid enclosure as it charges with hydrogen. Rigid components, such as mounts or fluidic devices for fuel cell communication, can be coupled to the fluid enclosure through the flexible interface and not risk sheering due to mechanical stress. The flexible interface allows for more component configurations and applications for use with a flexible fluid enclosure. The flexible interface absorbs strain and supports the connection between component and enclosure. Additional examples and details can be found in commonly owned co-pending U.S. patent application Ser. No. 12/052,829, entitled “Interface For Flexible Fluid Enclosures,” filed on Mar. 21, 2008, which was issued as U.S. Pat. No. 7,926,650 on Apr. 19, 2011 and which is incorporated herein by reference in its entirety.

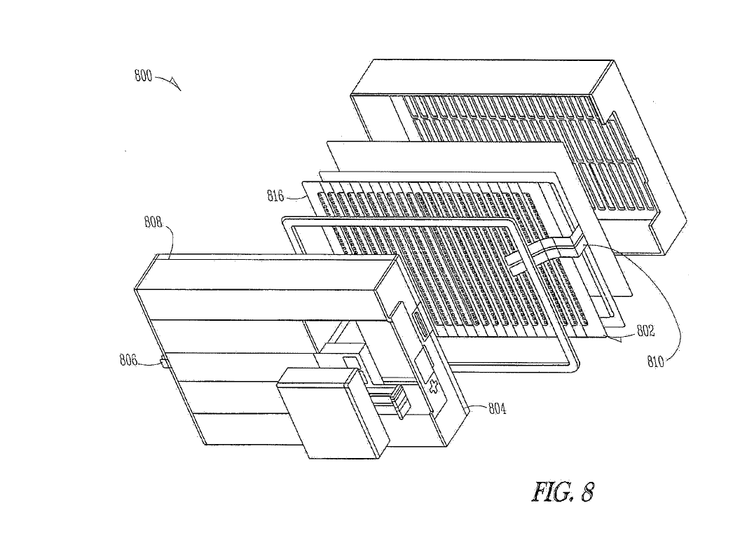

Referring to FIG. 6, a cross-sectional view of a flexible fluid enclosure interface system 400 is shown, according to some embodiments. The system 400 includes a flexible fluid enclosure 406 in contact with a strain absorbing interface 404 on a first side. On a second side, the interface 404 may be in contact with a featured layer 402. The featured layer may include a plurality of featured layers, or one or more featured layers that collectively form a functional control system component. An optional fluidic connection 408 may be positioned in the strain absorbing interface 404, connecting the enclosure 406 and featured layer 402.

The fluid enclosure may be flexible. For example, a flexible fluid enclosure may include a flexible liner for storing a fluid. The fluid enclosure can include fuel cartridges, such as replaceable fuel cartridges, dispenser cartridges, disposable fuel ampoules, refillable fuel tanks or fuel cell cartridges, for example. The fuel cartridge may include a flexible liner that is connectable to a fuel cell or fuel cell layer. The fuel cartridge may also include a connecting valve for connecting the cartridge to a fuel cell, fuel cell layer or refilling device. The fluid enclosure 406 may be an enclosure formed by conformably coupling an outer wall to a composite hydrogen storage material, for example.

Conformably coupled refers to forming a bond that is substantially uniform between two components and are attached in such a way as to chemically or physically bind in a corresponding shape or form. A structural filler or composite hydrogen storage material may be conformably coupled to an outer enclosure wall, for example, in which the outer enclosure wall chemically or physically binds to the structural filler or composite hydrogen storage material and takes its shape. The outer enclosure wall is the outermost layer within a fluid enclosure that serves to at least partially slow the diffusion of a fluid from the enclosure. The outer enclosure wall may include multiple layers of the same or differing materials. The outer enclosure wall may include a polymer or a metal, for example. The fluid may he hydrogen, for example. Examples of such enclosures may be found in commonly owned U.S. patent application Ser. No. 11/473,591, entitled “Fluid Enclosure And Methods Related Thereto,” filed Jun. 23, 2006, which was issued as U.S. Pat. No. 7,563,305 on Jul. 21, 2009.

The strain absorbing interface 404 may be manufactured of any suitable material that allows it to be flexible, absorb strain, and bond to the enclosure 406 and featured layer 402. The material chosen should provide a suitable bond, physical or chemical, between the featured layer 402 and enclosure 406 and also allow for the differential in strain between the strain of the enclosure wall and the rigidity of the featured layer 402, so that the sheer stress on any bonds does not exceed the strength of such bonds. The strain absorbing interface 404 may be manufactured of an elastomeric material or silicon material, for example. Elastomeric materials may include thermoplastic elastomers, polyurethane thermoplastic elastomers, polyamides, melt processable rubber, thermoplastic vulcanizate, synthetic rubber and natural rubber, for example. Examples of synthetic rubber materials may include nitrile rubber, fluoroelastomers such as Viton® rubber (available from E.I. DuPont de Nemours, a Delaware corporation), ethylene propylene diene monomer rubber (EPDM rubber), styrene butadiene rubber (SBR), and Fluorocarbon rubber (FKM).

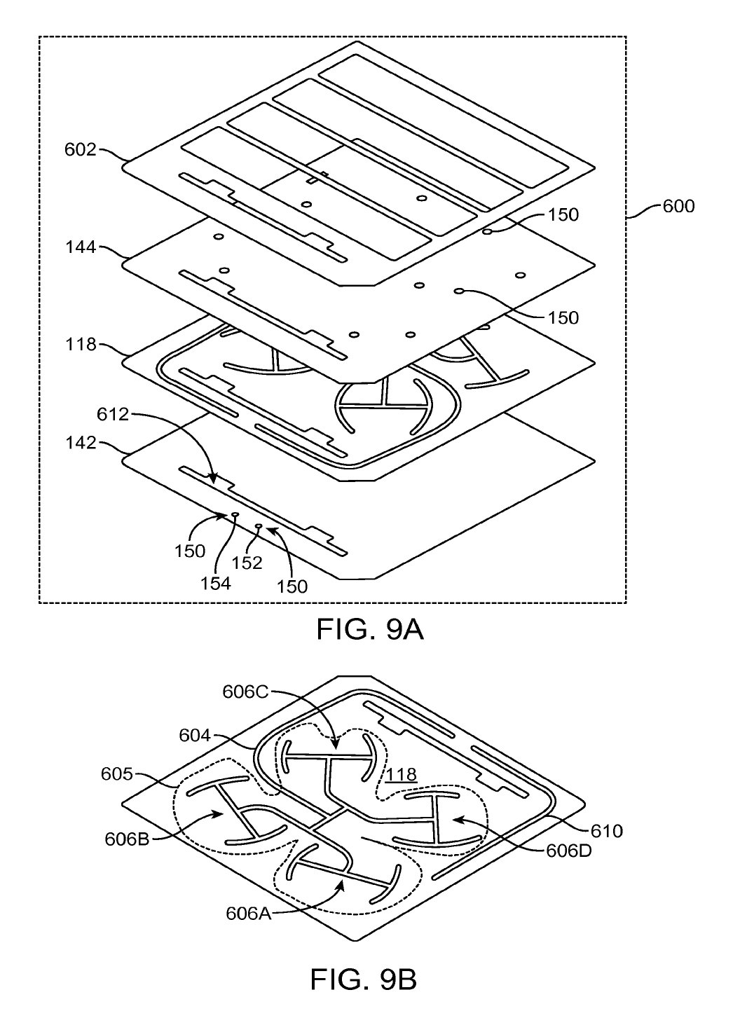

As the fluid enclosure 406 is filled with fluid, or charged, the dimensions of the enclosure 406 increase (see FIG. 7). The strain absorbing interface 404 may deform or change in dimension, such as in thickness 412, as it is strained (see FIG. 7). The strained interface 404 then maintains a consistent, less stressful contact between the enclosure 406 and featured layer 402.

The featured layer 402 would then undergo little to no strain, as the strained interface 404 absorbs strain caused by the enclosure 406 movements. The strained interface 404 may absorb all or at least part of the strain caused by changes in dimension of enclosure 406. The strain absorbing interface or the strained interface 404 may be generally characterized as interface elements.

The featured layer 402 may be any fitting, mount, connector, valve, regulator, pressure relief device, planar microfluidic device, a plate, or any device that might control the flow of a fluid from the fluid enclosure into or out of the enclosure or combinations thereof, for example.

Examples of fluids include, but are not limited to, gas, liquefied gas, liquid or liquid under pressure. Examples of fluids may include fluid reactants, fuels, oxidants, and heat transfer fluids.

Fluid fuels used in fuel cells may include hydrogen gas or liquid and hydrogen carriers in any suitable fluid form. Multiple strain absorbing interfaces 404 and multiple featured layers 402 may be utilized in conjunction with one or more fluid enclosures 406, where the featured layers form functional components such as, but not limited to, the fluidic control system, the manifold, the pressure regulator, the check valve. In another option, the interfaces 404 can be coupled with an inlet of the fluidic control system, the fuel cell, or the fluidic enclosure.

FIG. 1B illustrates additional examples for the manifold 118. A fuel cell assembly 100 includes a fluid enclosure 114 fluidly coupled with a fluidic controller, such as a pressure regulator component 116 by a manifold 118. The one or more fluid control components can include, but are not limited to a fluidic control system, inlets, outlets, a check valve component, a flow valve component, a charge valve component, pressure relief component, a conduit, an on/off valve, a manual on/off valve, or a thermal relief component.

The pressure regulator 116 is fluidly coupled with a fuel cell 102 via a manifold 118. The manifold 118 includes one or more conduit channels 130 therein, such as may provide a single ingress and multiple egresses as shown in FIG. 1B. In a further option, the manifold 118 fluidly coupled with the pressure regulator component 116 and the fuel cell 102 can further include at least one feedback channel or conduit 129 and a delivery channel 133. The delivery channel 133 delivers fluid such as a fuel to the fuel cell 102. The feedback channel 129 allows for the regulator to be piloted based on the feedback to the pressure regulator component 116 from pressure in the fuel plenum, and is fluidly coupled to a fluid plenum of the electrochemical cell system. Additional examples and details can be found in commonly owned U.S. patent application Ser. No. 12/053,408, entitled “Fluidic Distribution System And Related Methods,” filed on Mar. 21, 2008, which was issued as U.S. Pat. No. 8,133,629 on Mar. 13, 2012 and which is incorporated by reference in its entirety.

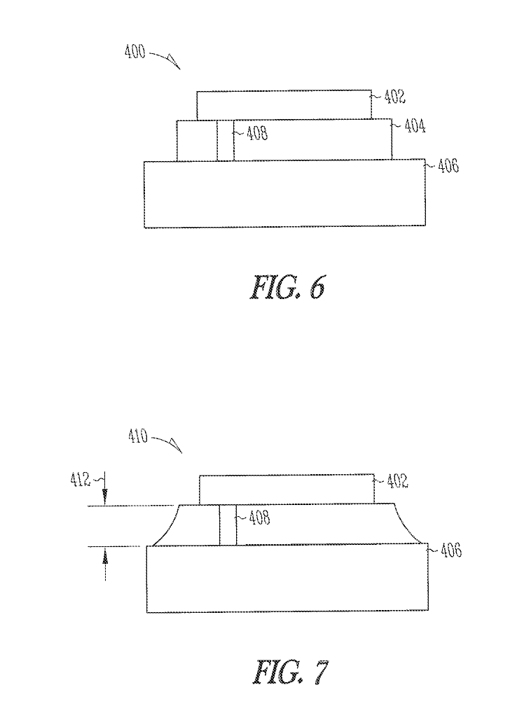

Each of the components of the electrochemical cell system 100 can be formed by the flexible layered structured as discussed above and below. In a further option, the one or more conduit channels 130 include a gas conduit channel. Multiple ports, channels, including conduit channels or delivery channels are possible, such as shown in FIGS. 5 and 6.

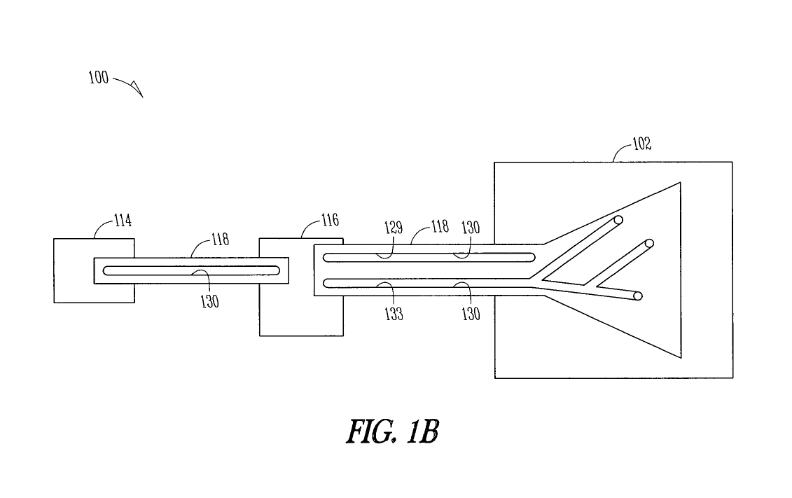

Referring to FIG. 2, the manifold 118, such as the fuel manifold 120, includes a layered structure formed of multiple, thin, flexible featured layers. The layered structure is made small, nano-fabrication technologies, and/or micro fabrication technologies can be employed to produce and assemble the layers. For instance, processes for producing and/or assembling the layers include, but are not limited to, microfluics application processes, or chemical vapor deposition for forming a mask, and followed by a process such as etching. In addition, materials for use in fabricating the thin layered structure include, but are not limited to, silicon, polydimethylsiloxiane, parylene, or combinations thereof. The manifold 120, as evident from FIG. 1A, includes a first manifold coupled to the fuel cell 102, and a second manifold connecting the first manifold to an outlet 206 that is fluidly connected to the fluid enclosure 114. Port 204 connects the first manifold to the outlet 202 of the second manifold.

The featured layers include one or more features. In an option, the featured layers of the layered structure provide a gas-tight seal such that the featured layers are gas-tight. For example, a bond is provided with the layers that is impermeable to a fluid. In another example, the bond may be substantially impermeable to hydrogen or any other fluid at or below 350 psi or 2.5 MPa. Examples of fluids include, but are not limited to, hydrogen, methanol, formic acid, butane, borohydrides, water, air, or combinations thereof. In another option, the bond is substantially impermeable to fluid at or below 150 psi or 1.03 MPa. In yet another option, the bond is substantially impermeable to fluid at or below 15-30 psi or 0.10-0.21 MPa. The layered structure allows for the manifold to be of a size that does not take up unnecessary volume, nor an unnecessarily large footprint, yet allows for the pressure, volume, and temperature requirements for fuel cell fuel supply systems to be met. The multiple layers can be coupled together by thermal bonding, adhesives, soldering, ultrasonic welding, etc.

The manifold 118 can be made of relatively thin layers of material, allowing for the manifold 118 to be flexible. In an option, the manifold 118, and/or the featured layers that make up the manifold 118, such as, but not limited to the conduit layer 122 and/or the barrier layer, are flexible enough to have a bend radius of about 1 to about 5 mm. In a further option, the manifold 118, and/or the featured layers, and/or the conduit layer 122, and/or the barrier layer have a bend radius of no less than about twice a thickness of a single featured layer, where the thickness is optionally less than about 200 microns to about 1 mm. The flexible manifold can be bent around components, or wrapped around components, providing a greater number of assembly options for the electrochemical cell system.

The manifold 118, for fluid, includes at least one featured layer, such as a conduit layer 122 defined in part by a first side 124 and a second side 126. In an option, the at least one conduit layer 122 is relatively thin, for example, compared with the length and width. In an example, the thickness of the at least one conduit layer 122 is generally less than about 1 mm. In another example, the thickness of the at least one conduit layer 122 is about 5 μm-1 mm. In an example, the width and length of the conduit layer 122 is about 1 mm and 100 μm, respectively. In another example, the thickness of the at least one conduit layer 122 is about 100 μm, and the width and length of the conduit layer 122 is about 1 mm and about 1.5 mm, respectively. The width and/or the length can be altered for geometry of the system in which the manifold 118 is installed.

In a further option, the thickness of the layer is about 10 to about 500 micron, and a dimension of the conduit channel, such as a height or a width or a channel depth, is about 50 micron to 1 mm. The layer is highly planar such that a width of the manifold is greater than about thirty times the dimension of the conduit channel. In another option, the width of the planar portion of the manifold is greater than three times the dimension of the conduit channel.

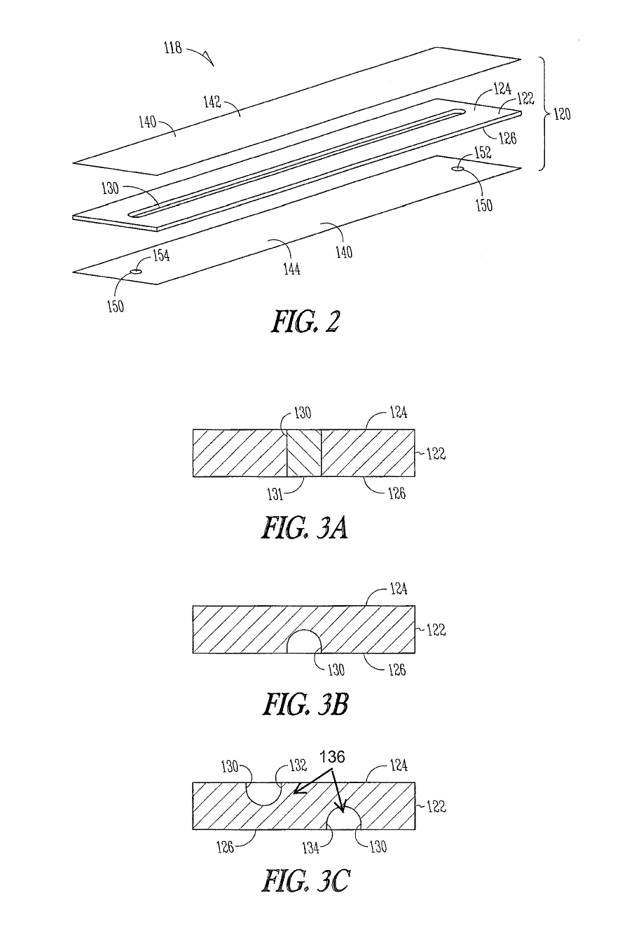

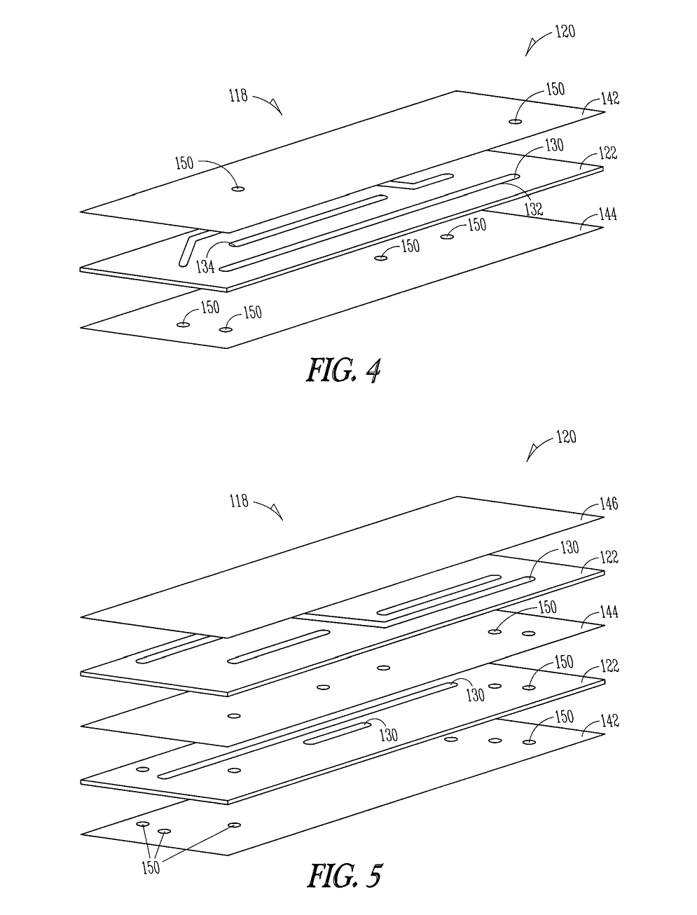

The at least one conduit layer 122 includes at least one conduit channel 130 therein. In an option, the conduit layer 122 includes a plurality of conduit channels 130 in the conduit layer 122, and in a further option, in each of the conduit layers 122. The plurality of conduit channels 130 are disposed adjacent one another in a single layer. The at least one conduit channel 130 can also be a recess or a partial recess or channel, and is a conduit channel that allows for material such as a fluid to flows there through. The at least one conduit channel 130, in an option, extends through the conduit layer 122, from the first side 124 to the second side 126, as shown in FIG. 2 and FIG. 3A. In another option, the at least one conduit channel 130 extends only partially within a side of the conduit layer 122, as shown in FIG. 3B. In yet another option, the conduit layer 122 includes two or more conduit channels 130, within a single conduit layer. For example, two or more conduit channels 130 which extend from the first side 124 to the second side 126 can be disposed within the conduit layer 122, as shown in FIG. 4. The two or more conduit channels 130 can include recesses that extend partially within a side of the conduit layer 122 (FIG. 3B) and/or the conduit channels 130 can extend through the conduit layer 122 (i.e. from the first side 124 and through the second side 126). The conduit channels 130 that extend partially within the featured layer optionally can be fluidly coupled with one another.

The two or more conduit channels 130 can be formed within the featured layer such as the conduit layer 122 such that they do not intersect with one another in the conduit layer 122. Alternatively, the two or more conduit channels 130 can be formed within a featured layer such as the conduit layer 122 such that they do intersect with one another or are fluidly coupled in the conduit layer 122. The conduit channel 130 extends along the conduit layer 122, and allows for material such as fluid or fuel to flow there through. In an option, the conduit channels 130 and/or ports are sized and positioned so that flow there through is non-restrictive, which can be combined with any of the embodiments discussed above or below. For example, the conduit channels 130 and/or ports are sized similarly throughout the manifold so that flow there through is not restricted by changing the cross-sectional size of the channels or ports. In a further option, the conduit channels are delivery channels, where the channels deliver fluid such as a fuel. In a further option, the conduit channels include a feedback channel, for example for varying actuation of a regulator based on the pressure in a fuel cell fuel plenum. In yet another option, the conduit channel is a gas conduit channel.

In a further option, the conduit channel includes a channel having a surface allowing for non-restrictive flow. For example, the conduit channel has a surface roughness that is 1/50^{th} of the hydraulic diameter of the channel. In a further option, the fluid for the conduit channel includes a gas, such as a low viscosity fluid that reduces inhibitive capabilities of the channels, including, but not limited to hydrogen.

In another option, a conduit channel such as a first recess 132 can be formed on the first side 124 of the conduit layer 122, and a second recess 134 can be formed on the second side 126 of the conduit layer 122, where the first recess 132 and the second recess 134 do not necessarily extend from the first side 124 through to the second side 126. In an example shown in FIG. 3C, the partial conduit channels or recesses 136 are disposed on opposite sides of the conduit layer 122, allowing for material to travel there through via the recesses on the first side 124 and the second side 126.

The conduit layer 122, in another option, is formed of metals, plastics, elastomers, or composites, or a combination thereof. The at least one conduit channel 130 is formed within and/or through the conduit layer 122, in an option. For example, the at least one conduit channel 130 can be etched or stamped on, within and/or through the conduit layer 122. In another option, the at least one conduit channel 130 can be drilled within and/or through the layer, formed with a laser, molded in the conduit layer 122, die cutting the conduit layer 122, or machined within and/or through the conduit layer 122. In an option, the at least one conduit channel 130 has a width of about 5 to 50 times the depth of the recess. In another option, the at least one conduit channel 130 has a width of about 1 mm-2 mm. In yet another option, the at least one recess has a width of about 50-100 μm.

One of the featured layers of the manifold 118 further optionally includes at least one barrier layer 140, as shown in FIG. 2. The barrier layer defines a portion of the conduit channels 130, for instance a wall portion of the conduit channel 130. In a further option, the manifold 118 includes a first barrier layer 142 (which may be characterized as an upper barrier layer) and a second barrier layer 144 (which may be characterized as a lower barrier layer) disposed on opposite sides of the conduit layer 122. For example, the first barrier layer 142 abuts and seals against the first side 124 of the conduit layer 122, and the second barrier layer 144 abuts and seals against the second side 126 of the conduit layer 122. This allows for the conduit channel 130 to be enclosed and form a conduit through which material travels. The barrier layers 142, 144 can be coupled with the conduit layer 122, for example, but not limited to, using adhesives, bonding techniques, or laser welding. In a further option, the barrier layers 142, 144 and a featured layer such as the conduit layer 122 are stacked together, and further optionally sealed together. For example, the layers 122, 142, 144 are stacked and optionally coupled together through thermal bonding, adhesive bonding, gluing, soldering, ultrasonic welding, diffusion bonding, heat sealing, etc. In a further option, layers 122, 142, 144 are joined by gluing with cyanoacrylate adhesive. In yet another option, layers 122, 142, 144 could be built up and selectively etched as is done for MEMS and/or integrated circuits.

The layers 122, 142, 144, in an option, include one or more bonding regions 369 allowing for flowing adhesives or other bonding agents so that layers can be bonded without the functional components, the conduit channels, or ports also being bonded. In a further option, the one or more featured layers include barrier features, such as, but not limited to, physical barriers such as ridges, or recesses and/or chemical barriers that separate bonding regions from functional regions and/or prevent bonding material from entering function regions.

In a further option, the featured layers can form one or more of the barrier layers 142, 144 including one or more ports, perforation or holes 150 therein. For example, the one or more ports 150 or a first and a second hole to form an inlet 152 and an outlet 154. The inlet and outlet 152, 154 are positioned within the second barrier layer 144 such that they are fluidly coupled with the conduit channel 130. For example, the inlet and/or outlet 152, 154 are positioned adjacent to at least one conduit channel of another featured layer, for example as shown in FIGS. 2 and 4. Material such as fluid fuel can travel in through the inlet 152, through the conduit channel 130, and out of the outlet 154. The one or more ports 150 provide fluid communication between the manifold 118 and components which the fuel manifold 120 is coupled, such as, but not limited to, a fluid enclosure such as the fuel storage 108 (FIG. 1A) or the fuel cell 102 (FIG. 1A or 1B). The one or more ports 150 can further provide fluid communication within the manifold 118, for example, between various featured layers. It should be noted that it is possible to use the manifold 118 as a fluid distribution system where there is a single inlet 200 and multiple outlets 202 so that the manifold 118 feeds multiple locations, for example, on a fuel cell layer. FIG. 1A shows a manifold 118 with inlet 200 formed by a hole on a barrier layer and an outlet 202 formed by another hole on another barrier layer. Inlet 200 is fluidly connected to outlet 206 of fluid enclosure 108, 114, and outlet 202 is fluidly connected to port 204. The fluids usable with the manifold 118 include, but are not limited to: fuel, water, coolant, or oxidant. Examples of fluids which may be used could include, but are not limited to: hydrogen, methanol, ethanol, butane, formic acid, borohydride compounds such as sodium and potassium borohydride, and aqueous solutions thereof, ammonia, hydrazine, silanes, or combinations thereof.

In a further option, a filter element 131 can be incorporated into a part of the flow path. For example, the filter element 131 can be disposed within the conduit channel 130, as shown in FIG. 3A. In another option, the filter element 131 can be disposed within the ports 150, such as the inlet 152. The filter element 131 can include a porous substrate or a flow constricting element. In another option, the filter element 131 can define the conduit channel 130. The filter element 131 disposed within the conduit channel 130 and/or the ports 150 assists in preventing collapsing of the conduit channel 130 and/or port 150 for instance, when the fuel manifold 120 is bent around itself or other components within the fuel cell assembly. In a further option, the conduit channel 130 extends along the conduit layer 122, and the conduit channel 130 is defined by a length. The filter element 131, in an option, extends along a portion, or the entire length of the conduit channel 130. In an option, the filter element 131 is a porous substrate.

FIGS. 4 and 5 illustrate additional options for the manifold 118, where the fluid manifold includes multiple featured layers. Referring to FIG. 4, the fuel manifold 120 includes the at least one conduit layer 122, a first barrier layer 142, and a second barrier layer 144. The first barrier layer 142 and the second barrier layer 144 include one or more ports 150 therein. The at least one conduit layer 122 includes conduit channels such as a first recess 132, a second recess 134, and a third recess 136. The first, second, and third recesses 132, 134, 136 extend in a pattern within the conduit layer 122, and line up with their respective ports when the layers are stacked together, such that there is fluid communication. The barrier lavers 142, 144 can be coupled with the conduit layer 122 using, for example, but not limited to, adhesives, bonding techniques, or laser welding. In a further option, the barrier layers 142, 144 and the conduit layer 122 are sealed together.

FIG. 5 illustrates another example of a manifold 118, which also includes multiple featured layers. For instance, the manifold 118 includes multiple featured layers including at least two conduit lavers 122, a first barrier layer 142, a second barrier layer 144, and a third barrier layer 146. The conduit layers 122 for the various embodiments herein can serve as a barrier layer and conduit layer, and various features such as ports or conduit channels, or partially recessed channels can be formed in one or more of the featured layers, alone or in combination. The lavers include at least one conduit channel. The conduit channel includes, but is not limited to a delivery channel, or a feedback channel.

A first conduit layer is disposed between the first barrier layer 142 and the second barrier layer, and a second conduit layer is disposed between the second barrier layer 144 and the third barrier layer 146. It should be noted that additional layers, including conduit layers and barrier layers could be incorporated into the manifold 118 for additional material flow options.

The first barrier layer 142 and/or the second barrier layer 144 include one or more ports 150 therein. It is possible for the third barrier layer 146 to further include one or more ports 150 therein. The ports 150 allow for material to flow in to and out of the fuel manifold 120, and further to flow between the multiple conduit layers 122. The at least one conduit layer 122 includes one or more recesses 132, 134, 136 therein. The multiple recesses align with their respective ports when the layers are brought together, for example, by stacking the layers together and optionally sealing the layers.

The barrier layers 142, 144, 146 can be coupled with the conduit layers 122, for example, but not limited to, adhesives, bonding techniques, or laser welding. In a further option, the barrier layers 142, 144, 146 and the conduit layers 122 are sealed together. The various layers, including the featured layers and/or the barrier layers and/or the conduit layers allow for a flow path. In an option, a first flow path allows for fluid, such as gas, to be distributed on two more layers, where the first flow path extends from a first featured layer to a second featured layer. In yet another option, the flow path returns from the second featured layer to the first featured layer. In still another option, the first flow path circumnavigates a second flow path.

The fluid manifold provides a layered structure allowing for fuel distribution in a relatively small amount of space. For example, in some instances the fuel system can be made with an overall thickness of about 50-100 μm, or in another example the overall thickness is about 20-100 μm. The fuel cell fuel manifold further allows for the transport of fuel, such as gas, while maintaining certain levels of pressure. For instance, hydrogen gas can be distributed through the layered structure of the fuel manifold while pressure is in the range of 2-10 psig.

The fluid manifold interacts with or can be coupled to fuel cell or other system components using adhesives working over comparatively large surface areas so that the force due to internal fluidic pressures that is forcing the components apart is easily overcome by the strength of the adhesive bond. A high internal pressure can be counteracted with a bond that has a relatively low tensile strength.

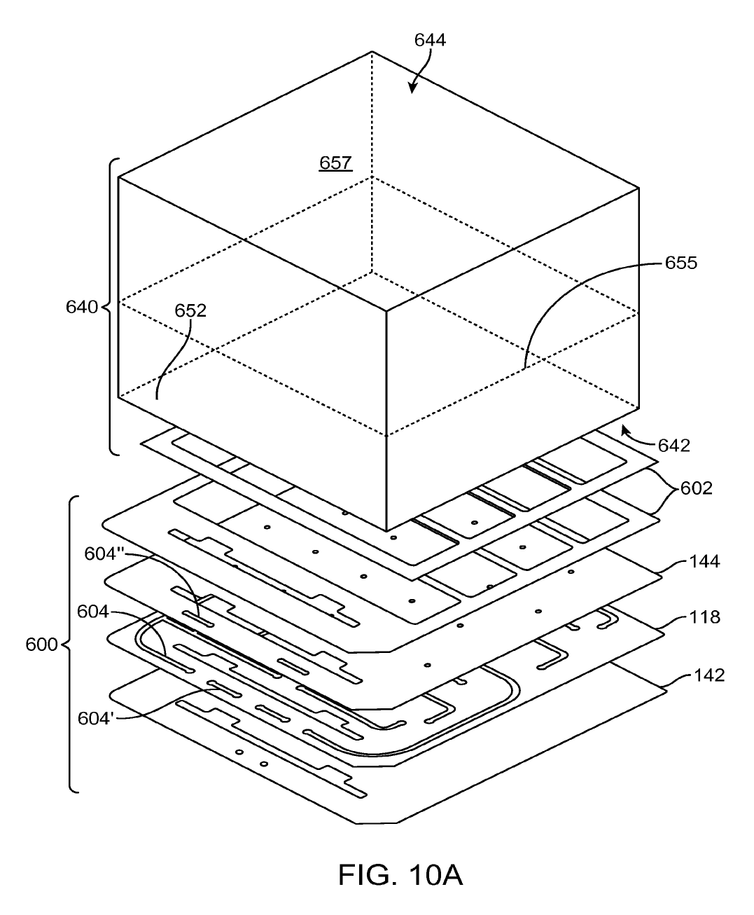

FIG. 8 illustrates another exploded view of an electrochemical cell system, as constructed in accordance with at least one embodiment. The fuel cell system 500 includes, but is not limited to, one or more of a fuel cell layer 502, fluidic controllers 504, a charge port or inlet 506, a fluid reservoir 508, or a current collecting circuit 510. In one example, the fluid reservoir 508 is filled with fuel by pressurizing the charge port or inlet 506. In another example, power from the fuel cell layer 802 is utilized by the current collecting circuit 510, which collects the power from the fuel cell layer 502 and routes it out of the fuel cell system 500.

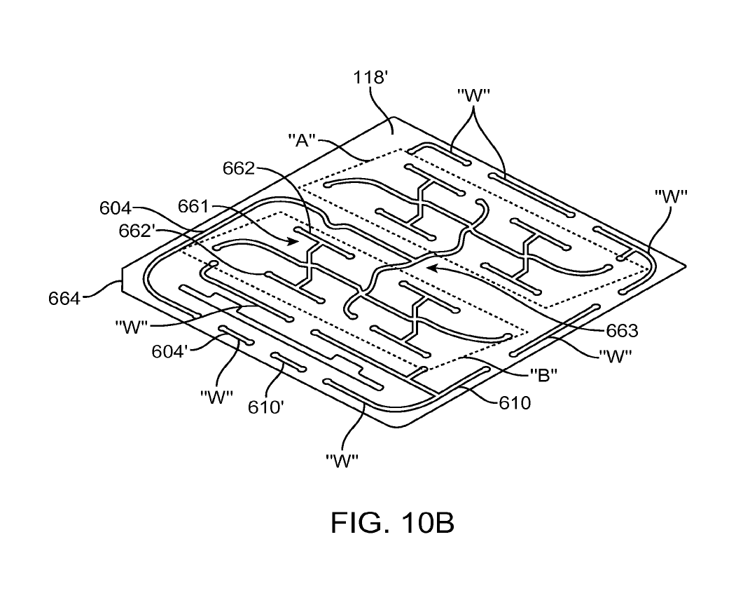

FIG. 9A shows one exemplary 4-layer manifold assembly 600 which utilizes a network of channels disposed on a single layer 118 to both regulate uniform distribution of fuel and removal of waste water and unreacted hydrogen from the anode. Subcomponents of the manifold assembly 600 include a perforated layer 144 and an optional support pedestal 602. The support pedestal may be optional and its support function may be incorporated into the layer structure forming the fuel manifold assembly 600.

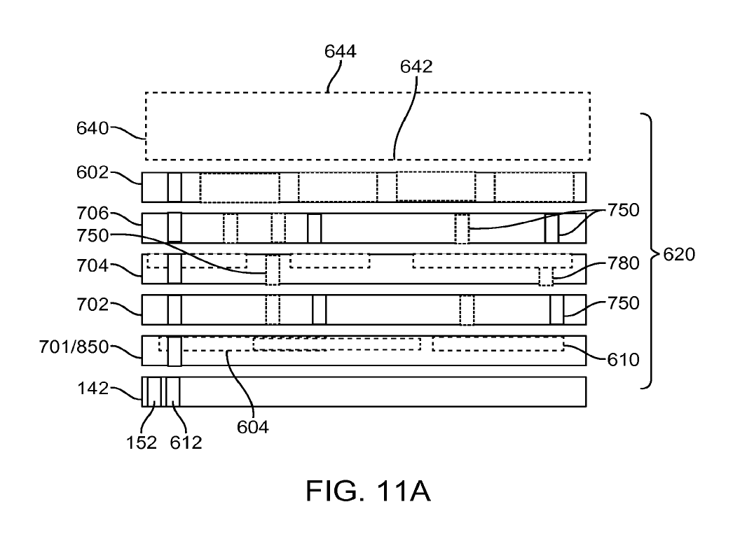

FIG. 9B shows an exemplary implementation of a manifold (conduit layer) 118 which may be used in a manifold assembly. The manifold provides a fluid path 604 which is shown as an intersecting network of conduits 605 that is fluid communication with fuel inlet port 152 in barrier plate 142. The fluid path in some instances is for routing hydrogen gas to the anode of a fuel cell to power a fuel cell. The fluid path branches to direct fuel to sub channels 606A-606D. The sub channels are part of a fuel distribution network on the layer. Some of the paths intersect as previously noted while others do not. The distribution model is to evenly distribute the fuel over a large surface area with a minimal footprint. The hydrogen is supplied to the fluid path 604 vis a vis an inlet 152 located at a port 150 through the first barrier layer 142. A water/waste outlet channel 610 is also provided in layer 118 whereby water, unreacted gas and other waste products from the anode layer 652 (see FIG. 10) are collected and removed through outlet port 154 in first barrier 142. In this disclosure, fluid transport in the manifold is driven via the pressure of the incoming fuel gas which both drives hydrogen through the manifold assembly and drives water out of the fuel manifold. Waste/water will negatively impact performance and operation if it accumulates in the assembly or restricts the flow of fuel through the fluid path 604 and through the fuel manifold (conduit layer). The water/waste exits the assembly via an outlet 154 in a port in the first barrier 142. A connection guide 612 may also be provided in the first barrier layer 142 whereby electrical connections to and from the fuel cell can be made.

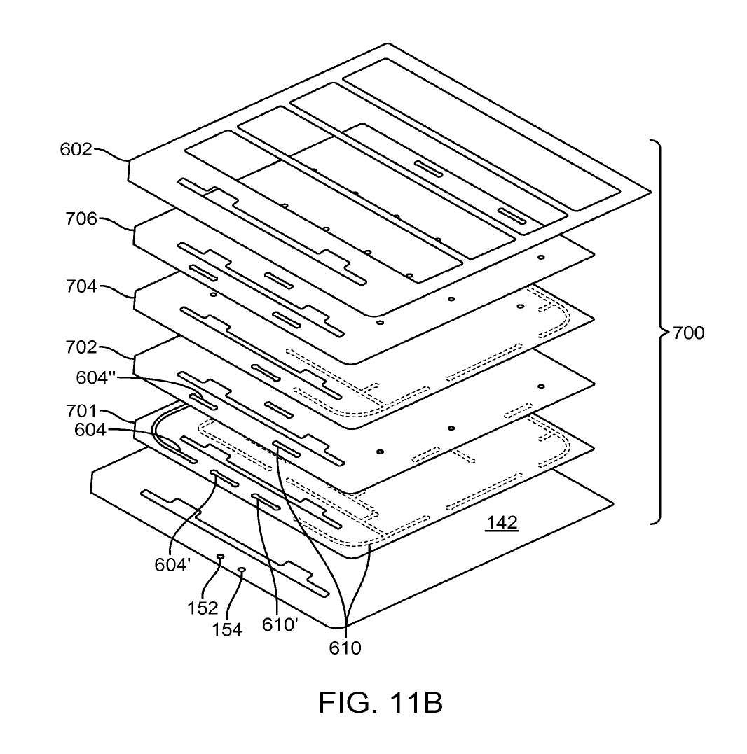

Shown in FIGS. 9A and 10A-10B are a manifold assembly, layers thereof, and a combined fuel cell assembly 640 and manifold assembly 600. The fuel cell assembly has a first side 642 (not shown in FIG. 11A) with a plurality of anodes, an ion conducting electrolyte membrane, and a second side 644 with a plurality of cathodes. The anode, membrane and cathode generally comprise the membrane electrode assembly (MEA) 655. The fuel cell assembly also has conductive elements which serve as current collectors. Examples of electrochemical cells comprising an underlying current collector are disclosed in commonly-owned U.S. patent application Ser. No. 11/047,560, titled “Electrochemical Cells Having Current Carrying Structures Underlying Electro Chemical Reaction Layers,” which was issued as U.S. Pat. No. 7,632,587 on Dec. 15, 2009; Ser. No. 12/242,231 titled “Methods Of Manufacturing Electrochemical Cells,” which was issued as U.S. Pat. No. 9,056,449 on Jun. 16, 2015; Ser. No. 12/920,064 titled “Electrochemical Cell And Membranes Related Thereto,” which was published as U.S. 2001/0003229 on Jan. 6, 2011; Ser. No. 14/346,208 titled “Methods Of Forming Arrays Of Fuelcells On A Composite Surface,” which was published, as U.S. 2014/0225313 on Aug. 14, 2014; and Ser. No. 14/359,041 titled “Methods Of Forming Fuel Cell Layers,” which was published as U.S. 2014/0317920 on Oct. 30, 2014; the disclosure of each of which is herein incorporated by reference in its entirety. As shown in FIG. 9A, second barrier layer 144 is positioned above the conduit layer (manifold) 118. Through-holes or ports 150 are formed in the second barrier layer. The through-holes are aligned with the fluid channel 604 for the passage of hydrogen fuel to the anode 652 of the fuel cell assembly 640. On the anode 652 side, hydrogen fuel ionizes, releases its electrons and creates protons (H⁺ ions). Electrons pass through an external electrical circuit to the cathode, while the protons diffuse through the MEA and is met at the cathode 657 end by an oxidant (oxygen or air). Water is produced at the cathode, which under certain circumstances could migrate to the anode side. The holes/perforations shown in layer 144 have a diameter of about 100 microns to about 300 microns. The size of the perforations can be varied depending on the many variables, for example the operating pressure of the fuel cell. If an operating pressure of 5.5 psig is desired, about 100 micron sized perforations may be preferably used, and if the operating pressure is 1.5 psig, the about 300 micron sized perforations may be preferably used, depending on operating conditions and variables. The perforated layer serves to regulate the flow of hydrogen to the anode layers of the fuel cell, and ensures substantially uniform flow distribution.

FIGS. 10A-10B show aspects of an exemplary manifold (conduit layer) 118/118′ and an exemplary second barrier 144/144′ for use in, a four-layer manifold assembly 600. This four layer manifold comprises a barrier layer 142, a conduit layer 118 (or alternatively 118′) comprising inlet and outlet channels/conduits as shown FIG. 10B, and a perforated barrier layer 144/144′ which may be set below an optional support plate 602. Conduit/manifold layer 118′ has a curved channel 661 between limbs 662 & 662′ and an additional curved channel 663 is provided between the main limbs “A” and “B” of this layer. Hydrogen enters through inlet hole 152 in barrier layer 142, flows through channels 604′, 604″ and 604 and is distributed through the limbs A and B. Hydrogen flow is then is regulated through inlet perforations 750 in barrier 144′ before reaching the anode. The perforation sizes range from about 100 microns to about 300 microns in this layer Waste (water and unreacted hydrogen) from the anode is removed through outlet perforations 750 in barrier 144 through channels 610 in plate 118′ and channel connections “W,” and exit through outlet hole 154 in first barrier layer 142. Waste connection channels are also formed through the barrier layer 144′. They provide a continuous fluid pathway for the “W” channels forming, the waste/water outlet 610. Because a less than 100% optimized manifold may have accumulation of waste water or condensation into the manifold layer 118,′ in some instances it is preferred to utilize curved pathway to avoid expanses of straight channel which will be susceptible to fluid buildup. Our testing has indicated the disclosed curved pathways used in the manifold 118′ described above provides more uniform hydrogen distribution and reduces any water accumulations.

FIGS. 11A-11C show an exemplary implementation of a 6-layer manifold assembly 700 with multiple layers within the manifold distribution network as previously described. In this fluid manifold 700 a plurality of barriers and channeled manifold layers are deployed. The manifold is a layered structure as previously described. There remain options with respect to adding additional manifolds whether they be waste/water removal specific, fuel inlet specific or used for both. Some of the layers will have channeled structures while others may only be perforated, and yet others can be a combination of both. The manifold layers are formed of a laminate which comprises the conduit layer that is sandwiched between a layer of an adhesive film on each side. Suitable adhesive materials include but are not limited to polyester and FR4, which is a composite material, composed of woven fiberglass cloth in an epoxy resin. Those of ordinary skill in the art will recognize that a planar fuel cell laminate may be comprised of multiple sheets of material forming that laminate and such design variations are within the scope of this disclosure.

The previously described ports/perforations range from about 30 microns to about 3000 microns. In some instances the ranges may be further separated into two group for ports that range in diameter from about 30-300 microns, in some instances about 200 microns ±about 100 microns and in some instance about 1000 microns to about 3000 microns. In other instance the range may be between about 50 microns and about 350 microns. In yet other instance the range for perforations or holes mabe between about 500 microns and about 3500 microns. One preferred exemplary implenations utilizes holes at about 2000 microns and perforations of either about 2000 microns and about 200 microns. In some instances it may preferred to have some perforations about 200 microns and others in the same layer in a range of 1-100 microns smaller or 1 to 100 microns larger. In some instances it may preferred to have some perforations or holes about 2000 microns and other perforations or holes in the same layer in a range of 100-1000 microns smaller or 100 to 1000 microns larger.

The fuel inlet conduit layer 701 has only channels or conduits and no perforations. The inlet 152 is fluidly connect to the fluid path 604 network of channels vis a vis the first partial inlet path 604′ which connect to the fluid path 604 via the second partial fluid path 604″. Similarly the outlet 154 is fluidly connected to the outlet channel 610 network of channels vis a vis the first partial outlet path 610′ which is connect to the outlet channel 610 via the second partial outlet path 610″. In some instance, straight limbs 703 at the ends of the fluid path may be utilized for this layer 701. Such straight limbs have fewer manufacturing problems than curved limbs and water and waste management can be less of a factor to consider in this inlet conduit layer 701 for an optimized manifold assembly. However, a combination of curved and straight limbs are an option and are within the scope of this disclosure.

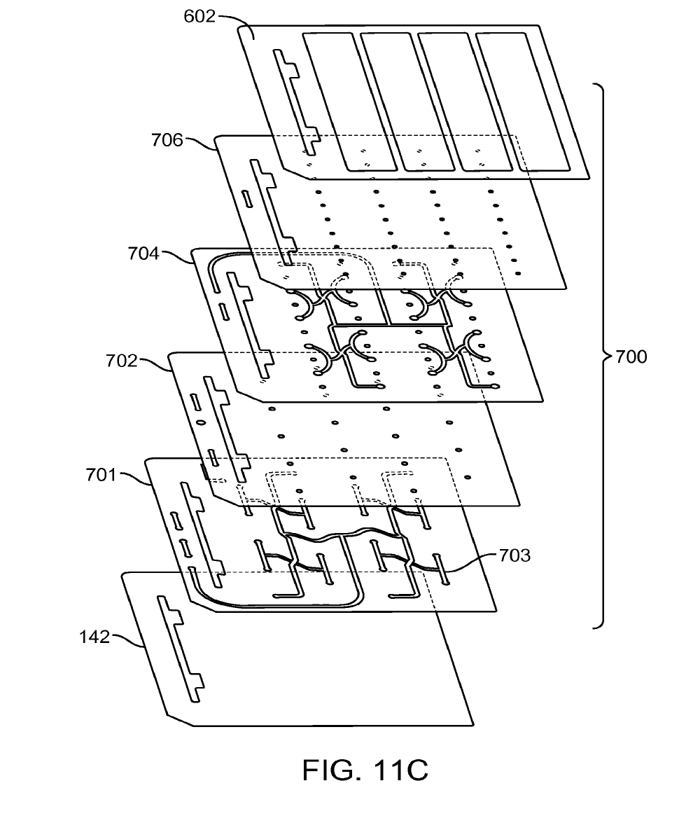

FIGS. 11A-14 show aspects of exemplary implementations of a multilayered manifold assembly disclosed herein. The second barrier 706 has perforations 755 some of which line up with the fluid path 604 and some which align with the outlet channels 610 of outlet conduit layer 704. The holes or perforations 755 in layer 706 are about 100 microns to about 300 microns in size and provide a fluid pathway through the barrier for hydrogen gas (or other hydrogen rich fuel), and an outlet for water and waste into the outlet conduit layer 704.

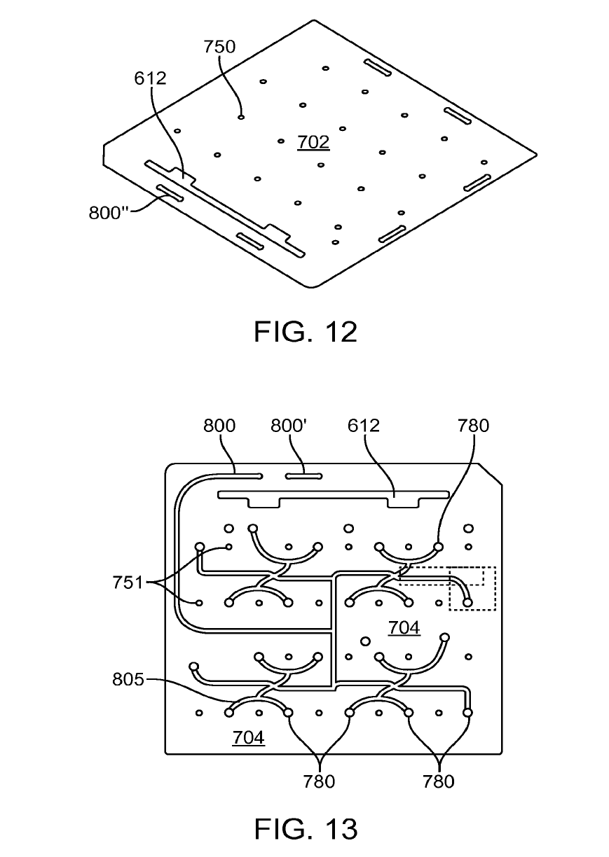

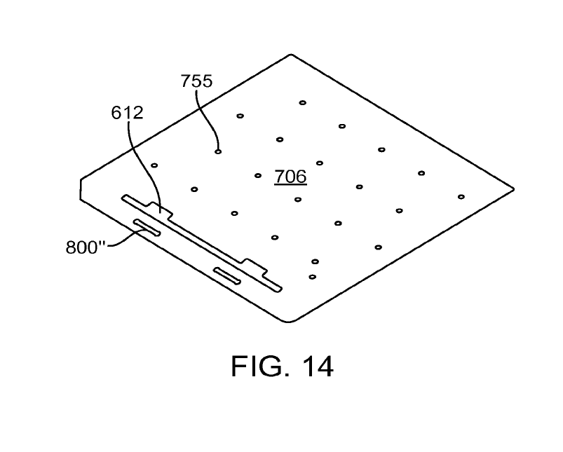

FIGS. 11A-11C show an exemplary 6-layer manifold assembly. The exhaust or outlet conduit layer 704 is shown in FIG. 11A-11C and FIG. 13 is disposed between the second barrier layer 702 and the third barrier layer 706. Above the third barrier layer 706 shown in FIG. 14 is the optional support layer or pedestal 602, which in some instances based on the stiffness of the other support structures or layers, cost, weight requirements, durability or usage the pedestal layer may be omitted. Those of ordinary skill in the art will recognize that a planar fuel cell laminate may be comprised of multiple sheets of material forming that laminate and such design variations are within the scope of this disclosure.

The exhaust layer 704 has a network of channels 800 therein and holes 751 whereby hydrogen (or other fuel) may pass as it is directed to the anode. These holes 751 are inlet holes and may range from about 1000 microns to about 3000 microns in diameter. The third barrier layer 706 further serves to regulate and uniformly distribute hydrogen other fuel) through inlet small perforations 755 found therein to the anode. The size of these inlet small perforations 755 may vary from 100 microns to 300 microns. The diameter of inlet holes may be adjusted depending on anode design, hydrogen inlet pressure and other factors to optimize performance and hydrogen distribution at the anode. The optimization of the manifold involves many variables including but not limited to pressure, temperature, use cycle, MEA, humidity and the like. Water and unreacted hydrogen from the anode is transported out through the outlet small perforations 755 found in barrier layer 706 to the externalities of the conduits or pathways 800 found in plate 704 (FIG. 13). These externalities may comprise of wells 780 that communicate with the outlet perforations found in barrier layer 706. The size of these wells could vary from 30 to 300 microns. Water collected in these wells is then transported out through the network of waste/water channels 800 to the outlet 154 located in barrier layer 142. Illustrated in FIG. 13 are curved limbs 805 placed in the water/waste collection fluid pathway 800 on plate 704 to manage localized water accumulation/condensation and efficiently remove waste water and unreacted hydrogen. Manage refers to reduce and/or prevent all but di minimis accumulations. As an air breathing or passive device has no fans or blowers to feed air to the cathode, and the accumulation of water which may prevent the exhausting as well as interfere with inlet of hydrogen via blocking the manifold assembly or parts thereof can reduce the function of a fuel cell device attached hereto or the delivery of fuel thereto or in some instances stop the device and flow of fuel. This layer 704 also provides inlet perforations 751 for hydrogen transport to the anode. The first barrier 702 has inlet perforations, which line up with the fluid path 604. These holes or perforations 751 are about 1000 microns to about 3000 microns in size and provide a fluid pathway through the barrier for hydrogen gas (or other hydrogen rich fuel). The manifold assembly may comprise a plurality of perforated layers and a plurality of conduit or manifold layers. The conduit layers may comprise of some portions that have perforations. The more than one perforated layers can be characterized by having homogeneous perforations, non-homogenous perforations or a combination of the thereof to achieve an optimum balance between uniform hydrogen distribution to the anode layers and removal of water formed at the anode layers and any unreacted hydrogen through the exhaust conduits to the at least one outlet in the first end layer.

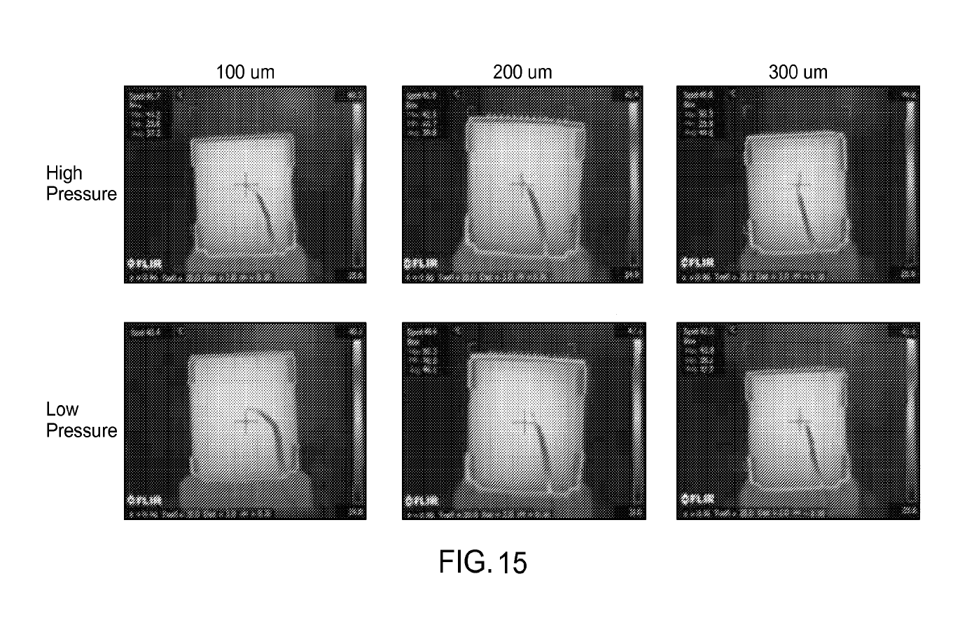

FIG. 15 are thermal images of an operational fuel cell being provided fuel via the manifold of FIGS. 11A-14. The images are significant that they show the even distribution of heat (red and yellow areas) over the surface of the device. If the fuel supply was delivered to the anode unevenly there would be regions of yellow, green or blue due to uneven hydrogen consumption and subsequent uneven heat generation in the electrochemical cell. Testing was conducted with perforation sizes in the barrier layer 706 from about 100 microns to about 300 micron. FIG. 15 contains images from testing wherein hydrogen gas was fed to an assembled planar fuel cell. Three tests were conducted by changing the perforations in third barrier layer 706 layer from about 100 microns to about 300 microns. The cathode side of the fuel cell was exposed to ambient air. In each test, the surface temperature of the fuel cell was monitored used a FLIR infra-red camera. The temperature profile was substantially uniform in each test, which indicates that the hydrogen flow distribution to the anode through the exemplary hydrogen manifold assembly was substantially uniform.

In the description of some embodiments of the invention, reference has been made to the accompanying drawings that form a part hereof, and in which are shown, by way of illustration, specific embodiments of the invention that may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the invention. The following detailed description is not to be taken in a limiting sense, and the scope of the invention is defined only by the appended claims, along with the full scope of equivalents to which such claims are entitled.

1. A fuel cell system with planar manifold comprising:
at least one fuel cell assembly (640) with a first side (642) and a second side (644);
a plurality of anodes on the first side;
a plurality of cathodes on the second side;
ion-conducting electrolyte between the first and second sides;
a fluid manifold assembly (600) fluidly connected to the first side; and,
wherein the fluid manifold comprises;
a first barrier layer (142) providing at least one inlet port (152) in fluid communication with a hydrogen source, and at least one outlet port (154) to remove any unreacted hydrogen and byproducts from the first side;
a plurality of conduit layers, on at least one (118) of which is disposed one or more channels (604) fluidly connected to the at least one inlet port and one of which (610) is fluidly connected to the at least one outlet port; and,
a second barrier (144) layer disposed above the plurality of conduit layers containing
a support pedestal (602) between the second barrier and the first side;
a plurality of perforations (150) affixed to the first side; and,
whereby the plurality of perforations supplies hydrogen gas.

2. The fuel cell system of claim 1 wherein the plurality of perforations receive waste and water from the anode and are fluidly connected via the manifold assembly (600) layers to the outlet.

3. (canceled)

4. The fuel cell system of claim 1 wherein the perforations more evenly distribute hydrogen over the first side then if the manifold did not have perforations.

5. A planar manifold assembly for delivering hydrogen to a fuel cell anode and removing waste and water comprising:
a first barrier layer (142) providing at least one inlet port (152) in fluid communication with a hydrogen source, and at least one outlet port (154) to remove any unreacted hydrogen and byproducts from the first side;
a plurality of conduit layers, on at least one (118) of which is disposed one or more channels (604) fluidly connected to the at least one inlet port and one of which (610) is fluidly connected to the at least one outlet port;
a second barrier (144) layer disposed above the plurality of conduit layers containing a plurality of perforations (150) affixed to the first side; and,
a support pedestal (602) above the second barrier;
whereby the second barrier is configured to be sealed to the anode side of a fuel cell assembly and the plurality of perforations supplies hydrogen gas more evenly over the anode then without perforations.

6. The assembly of claim 5 wherein the plurality of perforations are configured to receive waste and water from the anode of a fuel cell assembly and are fluidly connected to the outlet

7. (canceled)

8. The assembly of claim 5 wherein the perforations are between about 1000 microns and about 3000 microns in diameter.

9. The assembly of claim 5 wherein the perforations are between about 100 microns and about 300 microns in diameter.

10. The assembly of claim 5 wherein one or more channels intersect.

11. The assembly of claim 5 wherein a portion of at least one channel is curved.

12. (canceled)

13. A laminated planar manifold assembly comprising:
at least one fuel cell assembly (640) with a first side (642) and a second side (644);
a plurality of anodes on the first side;
a plurality of cathodes on the second side;
ion-conducting electrolyte between the first and second sides;
a fluid manifold assembly fluidly connected to the first side; and,
wherein the fluid manifold comprises;
a first barrier layer providing an inlet port (152) and an outlet port (154);
a manifold layer (701) to supply hydrogen to the anode side of a fuel cell and having a plurality of fluid paths (604) fluidly connected to the at least one inlet port and one or more water/waste outlet channels (610) fluidly connected to the outlet port;
a second barrier layer disposed above the first manifold having a plurality of perforations;
a support pedestal (602) above at least one of the second and third barrier layer;
an exhaust layer (704) having a plurality of channels for collecting water and waste from the anode side of a fuel cell and fluidly connected to the outlet;
a third barrier layer (706) disposed above the exhaust layer having a plurality of perforations;
whereby the inlet port is in fluid communication with a hydrogen source; and,
the plurality of perforations at least one of provide a fluid pathway for pressurized hydrogen gas flowing to the anode of a fuel cell assembly and provide a fluid pathway for water/waste from the anode of the of a fuel cell assembly.

14. A planar manifold assembly comprising:
a first barrier layer providing an inlet port (152) and an outlet port (154);
a manifold layer (701) to supply hydrogen to the anode side of a fuel cell and having a plurality of fluid paths (604) fluidly connected to the at least one inlet port and one or more water/waste outlet channels (610) fluidly connected to the outlet port;
a second barrier (702) layer disposed above the first manifold having a plurality of perforations (750);
an exhaust layer (704) having a plurality of channels (800) for collecting water and waste from the anode side of a fuel cell fluidly connected to the outlet and having holes (751) fluidly connected to the hydrogen input supply;
a third barrier layer (706) disposed above the exhaust layer having a plurality of smaller perforations (755);
a support pedestal (602) above the third barrier;
whereby the inlet port is in fluid communication with a hydrogen source; and,
the plurality of perforations, small perforations and holes at least one of provide a fluid pathway for pressurized hydrogen gas flowing to the anode of a fuel cell assembly and provide a fluid pathway for water/waste from the anode of the of a fuel cell assembly.

15. (canceled)

16. The assembly of claim 14 wherein the perforations are between about 1000 microns and about 3000 microns in diameter.

17. The assembly of claim 14 wherein the small perforations are between about 100 microns and about 300 microns in diameter.

18. The assembly of claim 14 wherein the fluid paths in the manifold have at least one of one or more intersecting channels, and;
one or more curved regions.

19. (canceled)

20. A planar manifold assembly comprising:
a first barrier layer providing an inlet port (152) and an outlet port (154);
a manifold layer (701) to supply hydrogen to the anode side of a fuel cell and having a plurality of fluid paths (604) fluidly connected to the at least one inlet port and one or more water/waste outlet channels (610) fluidly connected to the outlet port;
a second barrier (702) layer disposed above the first manifold having a plurality of perforations (750);
an exhaust layer (704) having a plurality of channels (800) for collecting water and waste from the anode side of a fuel cell fluidly connected to the outlet and having holes (751) fluidly connected to the hydrogen input supply;
a third barrier layer (706) disposed above the exhaust layer having a plurality of smaller perforations (755);
whereby the inlet port is in fluid communication with a hydrogen source; and,
the plurality of perforations, small perforations and holes at least one of provide a fluid pathway for pressurized hydrogen gas flowing to the anode of a fuel cell assembly and provide a fluid pathway for water/waste from the anode of the of a fuel cell assembly;
wherein the channels in the exhaust layer have one or more intersecting channels, and;
wherein the channels in the exhaust layer have one or more curved limbs (805).

21. The assembly of claim 20 wherein the channels in the exhaust layer have one or more curved regions.

22. (canceled)

23. The assembly of claim 22 wherein at least one well (780) is formed at the end of a curved limb.

24. A method for evenly distributing hydrogen over an anode via a planar manifold the method comprising:
forming planar manifold comprising a stack of layers in the following sequence;
placing a first layer with a barrier an inlet port and an outlet port;
placing a second layer with a manifold layer having a plurality of fluid paths fluidly connected to the at least one inlet port and one or more water/waste outlet channels fluidly connected to the outlet port in fluid contact with the first layer;
placing a third layer barrier (702) above the second layer manifold having a plurality of perforations each having a diameter of between about 1000 microns and about 3000 microns fluidly connected to the previous layers;
placing a fourth layer for exhaust layer having a plurality of channels for collecting water and waste from the anode side of a fuel cell fluidly connected to the outlet and having holes with a diameter of between about 1000 microns and about 3000 micron fluidly connected to the previous layers;
placing a fifth layer barrier (706) disposed above the fourth layer having a plurality of smaller perforations each having a diameter of between about 100 microns and about 300 microns fluidly connected to the previous layers;
whereby the inlet port is in fluid communication with a hydrogen source; and, the plurality of perforations, small perforations and holes at least one of provide a fluid pathway for pressurized hydrogen gas flowing to the anode of a fuel cell assembly and provide a fluid pathway for water/waste from the anode of the of a fuel cell assembly.

25. The method of claim 24 wherein the combination of selectively sized perforations in several layers more evenly distributing hydrogen over an anode of a fuel cell assembly.

26. The method of claim 25 wherein the holes are about 1000 and about 2000 microns in diameter, the small perforation are between about 100 and about 300 microns in diameter and the perforation are between about 1000 and 3000 microns in diameter.

27. (canceled)
